(19) United States
(12) Patent Application Publication
(10) Pub. No.: US 2003/0120655 A1
(43) Pub. Date: Jun. 26, 2003

(54) Document processing apparatus

(76) Inventors: Toshikazu Ohwada, Tokyo (JP); Katsumi Kanasaki, Tokyo (JP)

Correspondence Address: DICKSTEIN SHAPIRO MORIN & OSHINSKY LLP, 2101 L STREET NW, WASHINGTON, DC, 20037-1526, US

(21) Appl. No.: 10/299,831

(22) Filed: Nov. 20, 2002

(30) Foreign Application Priority Data
Nov. 21, 2001 (JP) 2001-356360
Oct. 30, 2002 (JP) 2002-316368

(51) Int. Cl. G06F 17/30

(52) U.S. Cl. 707/9

(57) ABSTRACT

In a document processing apparatus, a change information obtaining part obtains access right change information indicating a method for setting or changing access rights indicated by a user by displaying a screen allowing the user to set or change the access rights of documents immediately under an indicated folder and descendant folders lower than the indicated folder, and an access right changing part changes the access right of the indicated folder and simultaneously changes a part or all of the access rights of the descendant folders obtained based on the hierarchical structure and the documents immediately under the indicated folder and the descendant folders based on the access right change information.

### BACKGROUND OF THE INVENTION

1. Field of the Invention

The present invention generally relates to document processing apparatuses including a document managing part capable of managing documents by folders, and more particularly to a document processing apparatus that enables to set and change an access right for each document managed by folders in a hierarchical structure.

2. Description of the Related Art

In a conventional document processing system such as a personal computer, a document filing system, or the like for dealing with a plurality of documents, a document after being processed is stored and managed in a storage part to be utilized again. A method, by which the document stored in the storage part is classified so as to be easily accessed and managed by folders created corresponding to the classification, is generally used. In addition, a method for classifying and hierarchizing the folders is applied with the above-mentioned method since a classification system can be easily understood by classifying the folders according to a hierarchical structure that shows a high order and a low order.

In the conventional document processing system, it is required to set an access right for each document or each folder and to manage each document in accordance with the access right. By setting the access right for each folder, it is possible to unify the management of the access rights for all documents maintained by the folders. On the other hand, an access management for each document can realize detailed access right management.

When the number of folders is increased as the number of documents is increased, the workload for changing the access right in respect to the folder or the document becomes greater. In a case in which the folders are managed in a hierarchical structure, if the access rights for folders and documents at lower layers can be changed by changing the access right for a folder at a higher layer, the workload can be reduced. In a file system of an operating system such as Microsoft Windows™ and UNIX™, it is possible to change the access rights for the objects at the lower layers at once. Japanese Laid-Open Patent Application No. 2000-90105 discloses a document management system in which the access right for a document is changed by utilizing such as the above-mentioned file system.

However, even in the above-mentioned file system, since the access rights for the objects at the lower layers are changed at once, detailed control to change the access rights for only some of folders at the lower layers or for the documents only cannot be realized. Since the file system lacks flexibility, it is not possible for a user to freely set a range of the access rights.

### SUMMARY OF THE INVENTION

It is a general object of the present invention to provide document processing apparatuses in which the above-mentioned problems are eliminated.

A more specific object of the present invention is to provide a document processing apparatus for conducting a document management that enables a user to change an access right for a document managed in a folder in a hierarchical structure, in which when the user changes the access right in respect to a folder indicated by the user, the access right can be set to documents belonging to the indicated folder, folders, and an entire document group located at lower layers than the indicated folder, or a part of the folders or a part of the documents under the indicated folder, so as to flexibly set the access rights and improve performance.

The above objects of the present invention are achieved by a document processing apparatus for controlling access rights of folders or documents so that the documents are maintained in the folders managed in a hierarchical structure, the document processing apparatus including: a change information obtaining part obtaining access right change information indicating a method for setting or changing the access rights indicated by the user by displaying a screen at a display unit, the screen allowing the user to set or change the access rights of the documents managed immediately under a folder indicated by the user and descendant folders lower than the indicated folder; and an access right changing part changing the access right of the indicated folder and simultaneously changing a part of or an entire access rights of the descendant folders obtained based on the hierarchical structure and the documents immediately under the indicated folder and the descendant folders based on the access right change information.

In the document processing apparatus according to the present invention, the user can be allowed by the change information obtaining part to set or change the access rights of the documents immediately managed under the indicated folder and of the descendant folders at lower layers than the indicated folder. And the access right changing part can set or change the access rights of a part or all of the indicated folder, the descendant folder, and the documents at once, corresponding to a combination of settings by the user.

For example, the descendant folders include all folders obtained by tracking folders toward lower layers from the indicated folder in accordance with the hierarchical structure.

The access right changing part may include a first determining part determining whether or not the access right change information obtained from the user by the change information obtaining part indicates to set or change the access rights of the documents immediately under the indicated folder, wherein based on a determination result by the first determining part and the access right change information, the access right changing part changes the access rights of the indicated folder and the documents immediately under the indicated folder.

In the document processing apparatus according to the present invention, the user can be allowed to set and change the access right of the folder indicated by the user and the access rights of the documents immediately under the indicated folder.

The access right changing part may include a second determining part determining whether or not the access right change information obtained from the user by the change information obtaining part indicates to set or change the access rights of the descendant folders at lower layers than the indicated folder, wherein based on a determination result by the second determining part and the access right change information, the access right changing part changes the access rights of the indicated folder and the descendant folders.

In the document processing apparatus according to the present invention, the user can be allowed to set or change the access right of the indicated folder indicated by the user and the access rights of the descendant folders at once.

The access right changing part may include a third determining part determining whether or not the access right change information obtained from the user by the change information obtaining part indicates to set or change the access rights of the documents immediately under the indicated folder and the descendant folders at lower layers than the indicated folder, wherein based on a determination result by the third determining part and the access right change information, the access right changing part changes the access rights of the indicated folder, the descendant folders, and the documents under the indicated folder and the descendant folders.

In the document processing apparatus according to the present invention, the user can be allowed to set or change the access right of the indicated folder indicated by the user and the access rights of the documents immediately under the indicated folder and the descendant folder from the indicated folder.

The access right changing part may change the access right of the indicated folder only when the access right change information obtained from the user by the change information obtaining part does not indicate to set or change the access rights of the documents immediately under the indicated folder and the descendant folders at lower layers than the indicated folder.

In the document processing apparatus according to the present invention, when the user does not set or change the access right of the documents immediately under the indicated folder and the access rights of the descendant folder, the user can set or change the access right of only the folder indicated by the user.

The access right changing part changes a setting for the user having the access right. Moreover, the access right changing part may change a setting of an access right type.

The above objects of the present invention can be achieved by a program code for causing a computer to conduct processes described above in the document processing apparatus or by a computer-readable recording medium recorded with the program code.

### BRIEF DESCRIPTION OF THE DRAWINGS

In the following, embodiments of the present invention will be described with reference to the accompanying drawings.

FIG. 1 is a block diagram showing a configuration of a first access right setting part according to the embodiment of the present invention;

FIG. 2A is a diagram showing a data structure of a document information table, FIG. 2B is a diagram showing a data structure example of a folder information table, FIG. 2C is a diagram showing a data structure of a user information table, and FIG. 2D is a diagram showing a data structure of a access right information table;

FIG. 3 is a block diagram illustrating a hierarchical structure of folders;

FIG. 4 is a block diagram showing a configuration of a second access right setting part according to the embodiment of the present invention;

FIG. 5 is a diagram showing a data structure of a folder hierarchical structure information table according to the embodiment of the present invention;

FIG. 6 is a block diagram showing a third access right setting part according to the embodiment of the present invention;

FIG. 7 is a diagram showing a data structure of a hierarchical structure information table according to the embodiment of the present invention;

FIG. 8 is a diagram illustrating an operation input screen of an access right setting I/F according to the embodiment of the present invention;

FIG. 9 is a diagram showing an input indicating a range of “only documents immediately under a target folder” at the screen in FIG. 8 according to the embodiment of the present invention;

FIG. 10 is a flowchart for explaining an access right change operation in the range of “only documents immediately under a target folder” in accordance with indications at a setting operation screen according to the embodiment of the present invention;

FIG. 11 is a flowchart for explaining a part of process for obtaining document IDs shown in FIG. 10, which is to apply all access right setting parts, according to the embodiment of the present invention;

FIG. 12 is a diagram for explaining a part of the process for obtaining document IDs shown in FIG. 10, which is to apply a “speed first priority type” according to the embodiment of the present invention;

FIG. 13 is a diagram showing an input indicating a range of “only descendant folders of the target folder” at the screen in FIG. 8 according to the embodiment of the present invention;

FIG. 14 is a flowchart for explaining an access right change operation in the range of “only descendant folders of the target folder” in FIG. 13 in accordance with indications at the setting operation screen according to the embodiment of the present invention;

FIG. 15 is a flowchart for explaining a process for obtaining the folder IDs in FIG. 14 for a “storage area first priority type” in FIG. 1 according to the embodiment of the present invention;

FIG. 16 is a flowchart for explaining a process for obtaining the folder IDs in FIG. 14 for a “storage area and speed compromise type” in FIG. 4 according to the embodiment of the present invention;

FIG. 17 is a flowchart for explaining a process for obtaining the folder IDs in FIG. 14 for the “speed first priority type” in FIG. 6 according to the embodiment of the present invention;

FIG. 18 is a diagram showing an input indicating the range of “documents immediately under the target folder” at the screen in FIG. 8 according to the embodiment of the present invention;

FIG. 19 is a flowchart for explaining an access right change operation in the range of “documents and descendant folders under a target folder in addition to documents immediately under the target folder” in accordance with indications at the setting operation screen according to the embodiment of the present invention;

FIG. 20 is a flowchart for explaining a process for obtaining object IDs for the “storage area first priority type” in FIG. 1 according to the embodiment of the present invention;

FIG. 21 is a flowchart for explaining a process for obtaining object IDs for the “storage area and speed compromise type” in FIG. 4 according to the embodiment of the present invention;

FIG. 22 is a flowchart for explaining a process for obtaining object IDs for the “speed first priority type” in FIG. 6 according to the embodiment of the present invention; and

FIG. 23 is a diagram showing a hardware configuration of a document processing apparatus according to the embodiment of the present invention.

### DESCRIPTION OF THE PREFERRED EMBODIMENT

In the following, an embodiment of the present invention according to a document processing apparatus will be described with reference to the accompanying drawings.

The embodiment illustrates an access right setting part that is provided in the document processing apparatus, manages documents under folders that are hierarchically structured, and allows a user to change a setting of an access right in respect to a document.

In this embodiment, as types of the access right setting part for the document, there are

storage area first priority type,

storage area and speed compromise type, and

speed first priority type.

The three types listed above will be illustrated in this embodiment. In the storage area first priority type, the document processing apparatus uses less storage area (disk, memory, or the like) but speed is slower. On the other hand, in the speed first priority type, the document processing apparatus uses greater storage area but the speed is faster. And characteristics of the storage area and speed compromise type are between those of the storage area first priority type and the speed first priority type.

The three types-will be described one by one.

[Storage Area First Priority Type]

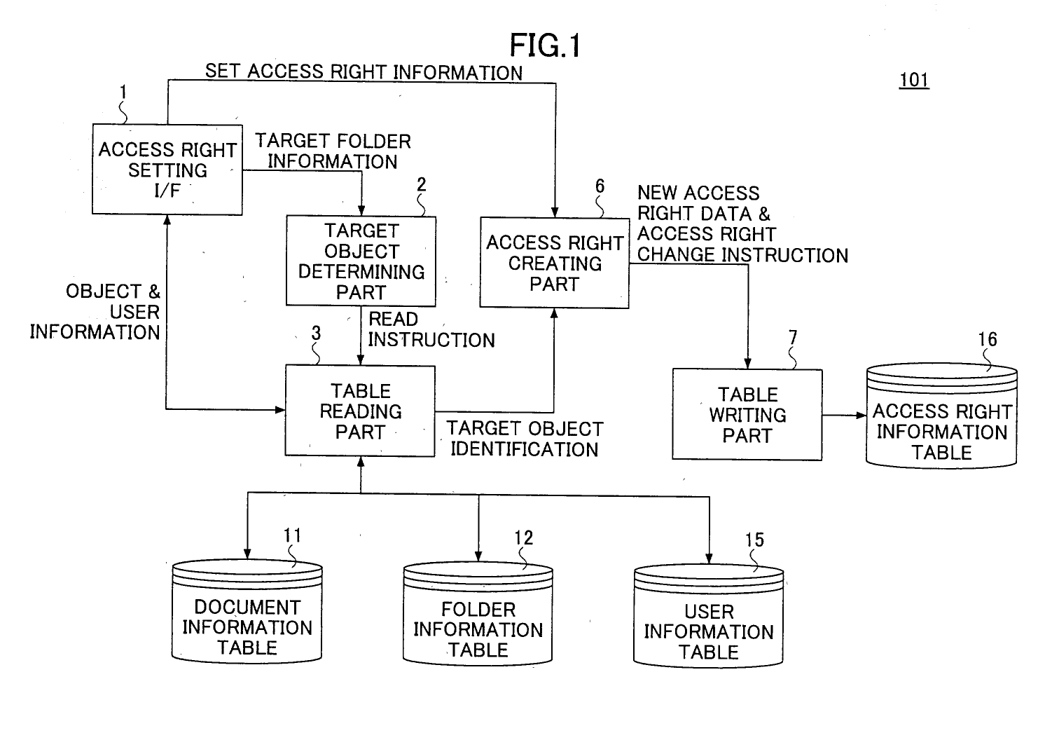

First, a configuration of a first access right setting part 101 in the storage area first priority type will be described with reference to FIG. 1.

FIG. 1 is a block diagram showing the configuration of the first access right setting part according to the embodiment of the present invention. In FIG. 1, each part is configured in a main system of the document processing apparatus (not shown).

As shown in FIG. 1, the first access right setting part 101 includes an access right setting I/F 1, a target object determining part 2, a table reading part 3, an access right creating part 6, a table writing part 7, a document information table 11, a folder information table 12, a user information table 15, and an access right information table 16.

The document information table 11, the folder information table 12, and the user information table 15 are tables to register and manage a document, a folder, and information concerning the user that are currently managed in the document processing apparatus, as data in which the access right is set. The access right information table 16 is a table to register and manage access right information set or changed by the user. Each of the information tables 11, 12, 15, and 16 can be provided in a database system or a file system of the main system. Each of the information tables 11, 12, 15, and 16 will be described later in detail.

The access right setting I/F 1 is called when the user tries to change the access right in respect to a certain object (a folder or a document). In the access right setting I/F 1, when object information or user information is displayed or the access right is set, for example, a dialog screen is provided to allow the user to select the target object where the access right is set, a content of the access right, access right type of the user having the access right, and the like. In accordance with an instruction input by the user, the target object information, the access right information, and the like are output.

The target object determining part 2 receives the target information selected by the access right setting I/F 1 to change the access right, determines the target object, and outputs a result as a read instruction.

The table reading part 3 reads information maintained in the document information table 11, the folder information table 12, and the user information table 15 in response to instructions from the access right setting I/F 1 and the target object determining part 2, and then outputs the information to the access right setting I/F 1 or the access right creating part 6.

The access right creating part 6 creates new access right information or access right change instruction based on set access right information received from the access right setting I/F 1 and target object ID information received from the table reading part 3.

The table writing part 7 receives data concerning the access right information created by the access right creating part 6, and writes to the access right information table 16 in accordance with the data. The table reading part 3 and the table writing part 7 switch an access means based on which means tables are provided.

The document information table 11, the folder information table 12, the user information table 15, and the access right information table 16 will be described in detail.

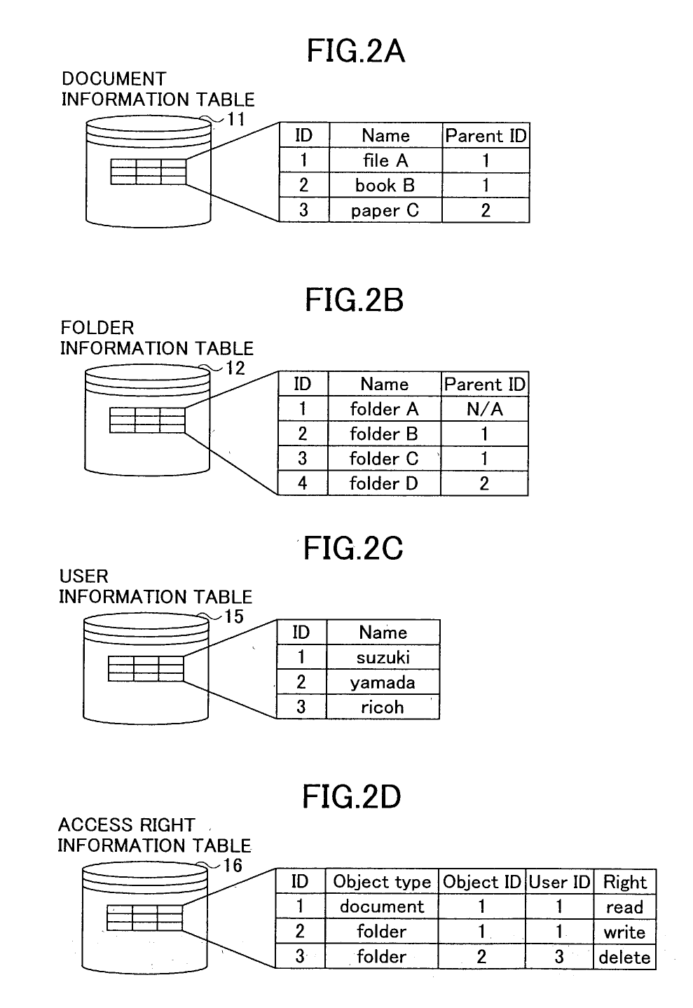

FIG. 2A through FIG. 2D are diagrams showing data structures of the information tables 11, 12, 15, and 16.

The document information table 11, the folder information table 12, and the user information table 15 are tables to register and manage documents, folders, and information concerning users, respectively, as data for setting the access right.

As shown in FIG. 2A through FIG. 2D, each table maintains information, and each row of the table is called a record that is a unit of information.

In the document information table 11 shown in FIG. 2A, a document ID is related to each document name, and data, which are determined in accordance with the hierarchical structure of the folders, are written to a parent ID of each document. The parent ID is an ID number of a folder which the document belongs to, and is set in the folder information table 12 in FIG. 2B.

In the folder information table 12 in FIG. 2B, a folder ID is related to each folder ID, and data, which are determined in accordance with the hierarchical structure of the folders, are written to a Parent ID of each folder. The parent ID is an ID number of a parent folder and is set in the folder information table 12.

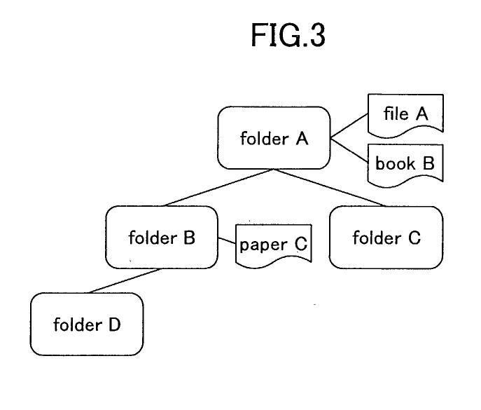

A concept of the hierarchical structure of the folders based on the document information table 11 in FIG. 2A and the folder information table 12 in FIG. 2B can be described as shown in FIG. 3. Referring to FIG. 3, a folder A has two documents of a file A and a book B immediately under the folder A, and has two folders of a folder B and a folder C as children folders. The folder B has a paper C as one document immediately under the folder B, and has a folder D as a child folder. The folder C and the folder D do not have a document or a child folder.

To track descendant relationships of the folders, it is required to see a parent folder of the folder information table 12 and track one folder by one folder. To check a document belonging to a descendant folder of a certain folder, it is required to check the parent folder in the document information table 11 simultaneously while tracking the folders.

In the user information table 15 in FIG. 2C, the user ID is related to each user name, and data concerning the user are written. In the user information table 15, no relationship is made between the document and the folder. However, if the access right of the user is limited, the relationship is required to be made between the document and the folder.

The access right information table 16 registers and manages the access right information that is currently set and changed by a setting operation.

In the access right information table 16 in FIG. 2D, an object type and an object ID are set so as to relate the access right ID to the target object where the access right is determined. For each object, the user ID having the access right (See the user information table 15 in FIG. 2C) and a “right” showing an access right type for the object are written. In FIG. 2D, “read” permits the user to read, “write” permits the user to write, and “delete” permits the user to delete.

[Storage Area and Speed Compromise Type]

A configuration of a second access right setting part 102 of the storage area and speed compromise type will be described.

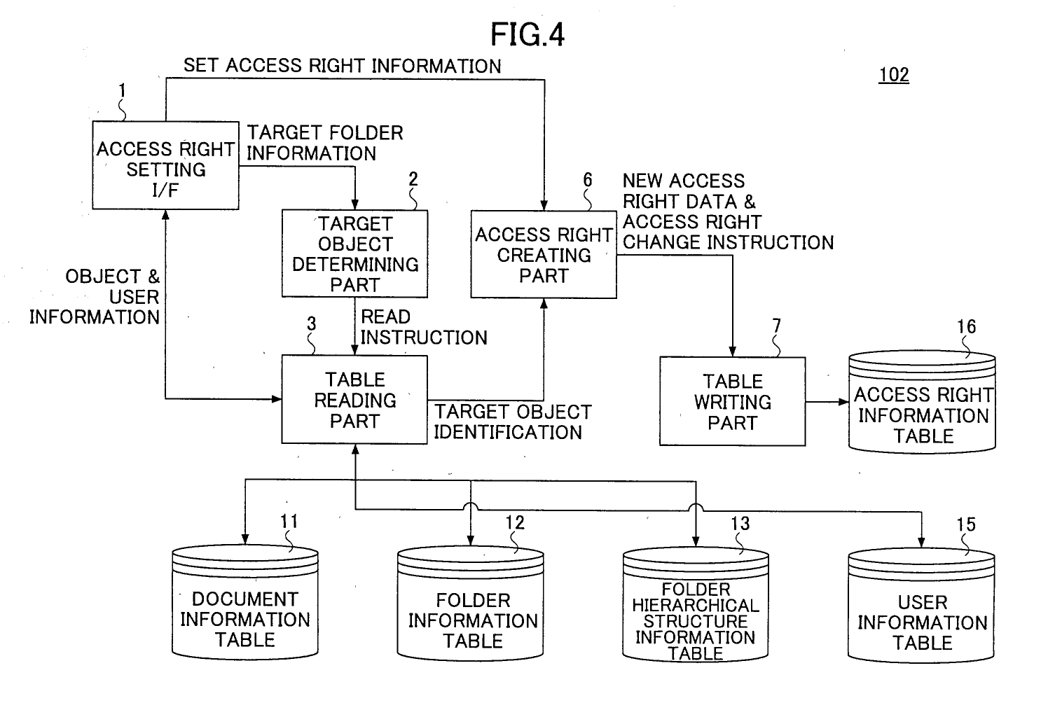

FIG. 4 is a schematic diagram showing the configuration of the second access right setting part according to the embodiment of the present invention. The second access right setting part 102 basically includes the same parts shown in FIG. 1 for the “storage area first priority type”, but the second access right setting part 102 additionally includes a folder hierarchical structure information table 13 to improve the speed of a setting process. Accordingly, explanation of the same parts will be omitted.

As shown in FIG. 4, similar to the folder information table 12, the folder hierarchical structure information table 13 additionally provided for the second access right setting part 102 registers and maintains information concerning the folders as data for the setting operation of the access right. The folder hierarchical structure information table 13 can refer to all folders, which layers are located as descendants, by a single operation.

The folder hierarchical structure information table 13 will be described referring to a conceptual diagram of the hierarchical structure of the folders shown in FIG. 3.

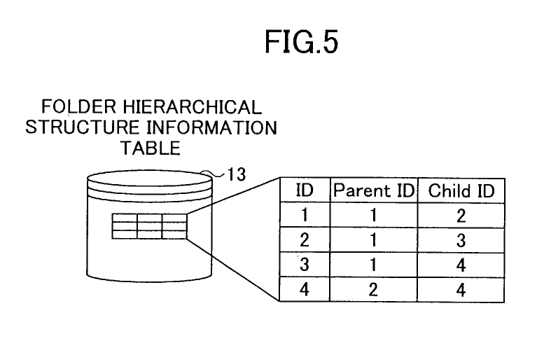

FIG. 5 is a diagram showing a data structure of the folder hierarchical structure information table according to the embodiment of the present invention.

The folder hierarchical structure information table 13 in FIG. 5 maintains all hierarchical relationships of the folders of not only a direct parent-child relationship but also descendant relationships. That is, descendants direct from the folder A are the folder B and the folder C, but the folder D and the folder A that are children of the folder B are also recorded in the folder hierarchical structure information table 13. As shown in FIG. 5, the folder hierarchical structure information table 13 records all descendant folders: child IDs 2 (folder B), 3 (folder C), and 4 (folder D) where the parent ID (ID number of a parent folder) is 1 (folder A).

By configuring tables as described above, it is possible to check all descendant folders of a certain folder at higher speed. In practice, since the number of documents is generally greater than the number of folders, the scale of the tables may be greater. Accordingly, it is needed to access the document information table 11 to check all documents that belong to the descendant folders of a certain folder. It is called the “storage area and speed compromise type” because of these characteristics described above.

[Speed First Priority Type]

A configuration of a third access right setting part 103 of the speed first priority type will be described.

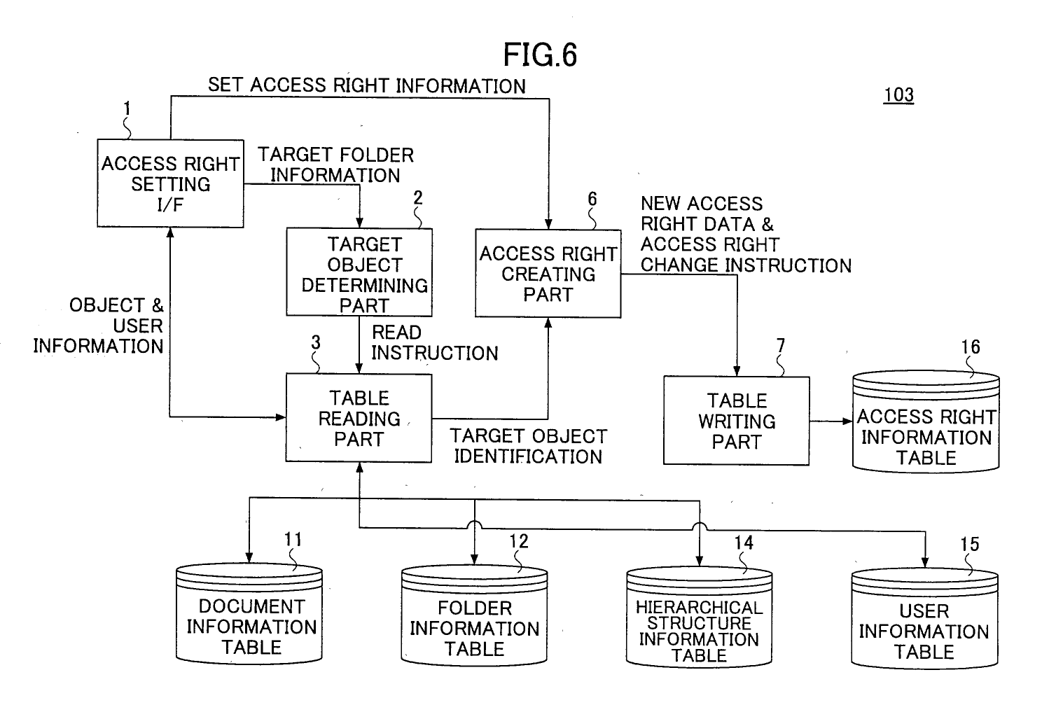

FIG. 6 is a block diagram showing the configuration of the third access right setting part according to the embodiment of the present invention. The third access right setting part 103 basically includes the same parts shown in FIG. 1 for the “storage area first priority type”, but the third access right setting part 103 additionally includes a hierarchical structure information table 14 to improve the speed of the setting process. Accordingly, explanation of the same parts will be omitted.

As shown in FIG. 6, similar to the document information table 11 and the folder information table 12, the hierarchical structure information table 14 registers and maintains information concerning the folders as data for the setting operation of the access right. The hierarchical structure information table 14 can refer to all folders, which layers are located as descendants, by a single operation. It can be said that the hierarchical structure information table 14 complements and advances hierarchical relationships of the documents in the folder hierarchical structure information table 13 installed in the “storage area and speed compromise type”.

The hierarchical structure information table 14 will be described referring to a conceptual diagram of the hierarchical structure of the folders shown in FIG. 3.

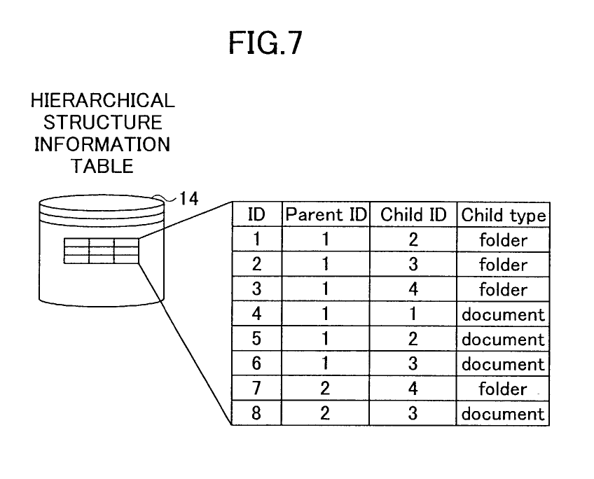

FIG. 7 is a diagram showing a data structure of the hierarchical structure information table according to the embodiment of the present invention.

The hierarchical structure information table 14 in FIG. 7 maintains all hierarchical relationships of the folders of not only a direct parent-child relationship but also descendant relationships. That is, descendants direct from the folder A are the folder B and the folder C, but the folder D and the folder A that are children of the folder B are also recorded in the hierarchical structure information table 14. As shown in FIG. 7, the hierarchical structure information table 14 records all descendant folders: child IDs 2 (folder B), 3 (folder C), and 4 (folder D) where the parent ID (ID number of a parent folder) is 1 (folder A). In addition, the paper C belonging to the folder B that is a child folder of the folder A is recorded as a descendant as well as the file A and book B belonging immediately to the folder A. That is, in FIG. 7, the hierarchical structure information table 14 records all descendant folders: child IDs 1 (folder A), 2 (folder B), and 3 (folder C) where the parent ID (ID number of the parent folder) is 1 (folder A).

By configuring tables as described above, in a case of checking the documents belonging to the descendant folders of a certain folder, since it is not required to access the document information table 11, the speed is even faster than the “storage area and speed compromise type”. However, since the hierarchical information table 14 becomes greater, this data structure in the third access right setting part 103 is preferably used when there is plenty of a storage capacity. It is called the “speed first priority type” because of these characteristics described above.

Operations of setting and changing the access right in respect to the documents will be described according to the embodiment of the present invention.

In this embodiment of the present invention, when the user indicates a folder (hereinafter, called indicated folder) to change the access right, it is allowed for the user to change the access rights of the folders and documents related to the indicated folder in accordance with the hierarchical relationship at once. In this case, the user is allowed to indicate a folder unit or a document unit immediately under the folder (including the indicated folder).

In the following, operations of setting and changing the access right will be described, in that for

(1) only documents immediately under a target folder,

(2) only descendant folders of the target folder,

(3) documents immediately under the target folder and all documents and folders descending from the target folder, the user can select any one of the above (1), (2), and (3) and can set or change the access right in respect to a range of target objects indicated by the user at once.

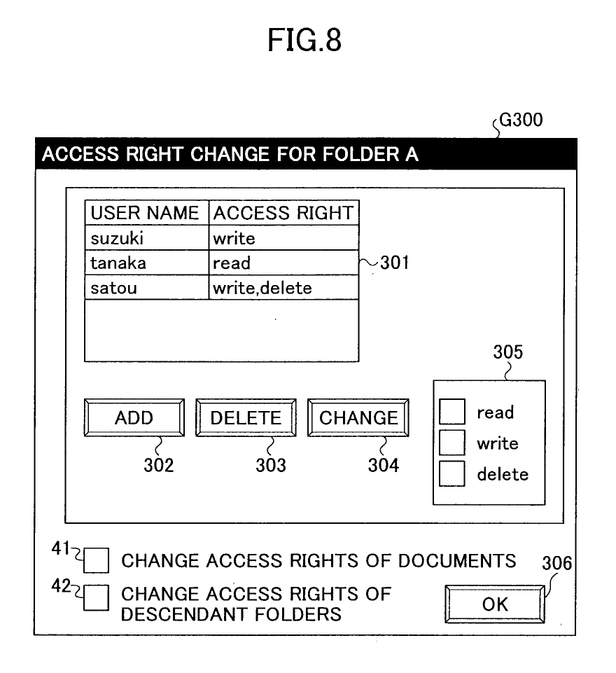

Before describing the above (1), (2), and (3), first, an operation input means commonly used for all operations of setting and changing the access right, that is, a screen used for operating or inputting by the access right setting I/F 1 is shown in FIG. 8, and input information that the user can indicate as information needed to set the access right.

FIG. 8 is a diagram illustrating an operation input screen of the access right setting I/F.

A setting operation screen G300 in FIG. 8 is displayed when the user indicates a folder (folder A in this example) and a request of setting or changing the access right from the access setting I/F 1.

At a top of the setting operation screen G300, a list 301 shows user names (“suzuki”, “tanaka”, and “satou”) who have the access right of the folder A at present, and access right types (“write”, “read”, and “write, delete”, respectively).

A button 302 showing “ADD” is provided to add a user having the access right for the folder A. When the button 302 showing “ADD” is pressed, a user list allowing the user to additionally set other users is read from the user information table 15, and displayed. Then, the user selects other users to add.

A button 303 showing “DELETE” is provided to delete a user having the access right for the folder A. Since the list 301 is displayed at the top of the setting operation screen G300 to show all users having the access right for the folder A, it is possible to select other users and press the button 303 showing “DELETE” to delete other users.

The button 304 showing “CHANGE” is pressed to change the access right for the folder A. A user is selected from the list 301 displayed at the top in the setting operation screen G300. Subsequently, at least one access right type is selected in a setting area 305 being a checkbox (possible to multiply check “read”, “write”, and “delete”), and then, the button 304 is pressed.

A checkbox 41 for changing the access rights of the documents is a checkbox of indicating whether or not the access rights of the documents immediately under the folder A are changed at once.

A checkbox 42 for changing the access rights of descendant folders is a checkbox of indicating whether or not the access rights of the descendant folders of the folder A are changed at once.

When a setting of the access right is completed in accordance with the operation described above, a OK button 306 is pressed to update data of the access right information table 16 based on setting contents changed by the user.

Each operation in which the user can set a range of setting or changing the access rights by enabling the user to indicate the above (1), (2), and (3) will be described.

(1) Operation of a Range of “Only Documents Immediately under a Target Folder”

In the operation (1), when the access right is changed so as to add the access right type in respect to the target folder where the access right is already set, the documents immediately under the target folder are added to the range of setting the access right and then the access rights of the target folder and the documents in the range are simultaneously changed.

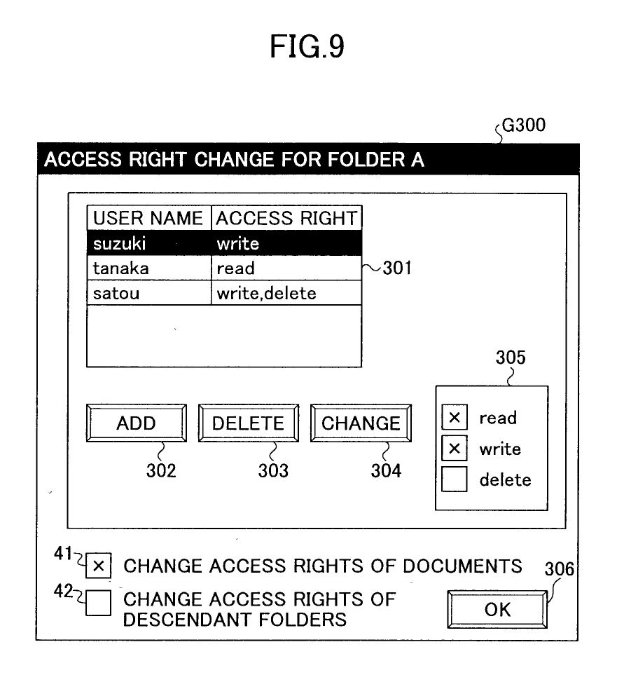

The operations are conducted by the user at the setting operation screen G300 (in FIG. 8) that is the dialog screen. FIG. 9 is a diagram showing an input indicating the range of “only documents immediately under a target folder” at the screen in FIG. 8.

As shown in the list 301 of the setting operation screen G300 in FIG. 9, a state (“read” in the setting area 305 is checked) is illustrated in that the access right “write” is already set for the user “suzuki” in respect to the folder A and the access right “read” is added.

When the checkbox 41 for changing the access rights of the documents is checked, the user “suzuki” and the access right “read, write” are set for the folder A and all documents immediately under the folder A. On the other hand, when the checkbox 41 is not checked, the access right of the folder A only is changed.

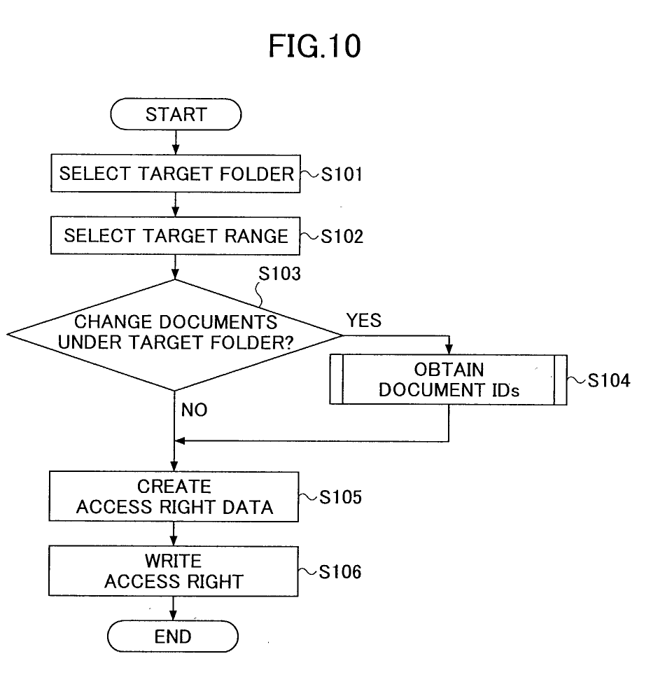

FIG. 10 is a flowchart for explaining an access right change operation in the range of “only documents immediately under a target folder” in accordance with indications at the setting operation screen according to the embodiment of the present invention. Each of the first access right setting parts 101, 102, and 103 can realize a process in accordance with the flowchart in FIG. 10 in the “storage area first priority type” (in FIG. 1) the “storage area and speed compromise type” (in FIG. 4), and the “speed first priority type” (in FIG. 6), respectively. However, if a different operation is possible for a part of each type, a different flowchart will be separately applied and described for each type.

Referring to FIG. 10, the user indicates the target folder by the access right setting I/F 1 and calls the setting operation screen G300 (in FIG. 8) for setting and changing the access right of the target folder (step S101). The user indicates changes of the settings of users having the access right or changes of the settings of the access right types for other users, and selects whether only the target folder is set as the range of changing the setting of the access right or the documents immediately under the target folder in addition to the target folder are set as the range of changing the setting of the access rights (step S102). That is, the checkbox 41 for changing the access rights of the documents is checked to change the access rights of all-documents immediately under the target folder in addition to the target folder.

This process is branched based on the existence of a check mark indicating whether or not “CHANGE ACCESS RIGHTS OF DOCUMENTS” is selected. Thus, it is determined whether or not the checkbox 41 is checked (step S103), that is, it is confirmed whether or not the access rights of the documents immediately under the target folder are simultaneously changed.

When the checkbox 41 is not checked (NO in step S103), since the access right of the folder A only is changed, in accordance with instructions at the setting operation screen G300 (in FIG. 9), the target folder information (folder A in this example) and the set access right information (user name “suzuki”, and access right type “read, write” in this example) are sent to the access right creating part 6 through respective processing parts, and then the access right data are created (step S105). After that, the table writing part 7 writes the access right data to the access right information table 16 (step S106), and updates and registers the access right information.

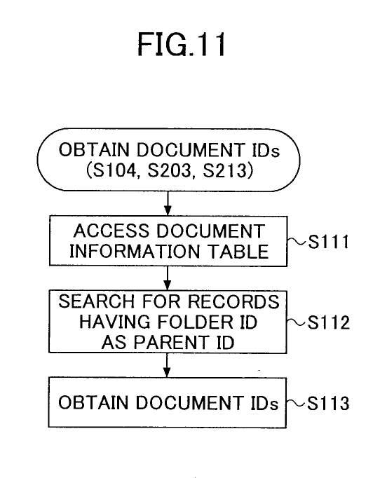

On the other hand, when the checkbox 41 for changing the access rights of the documents is checked (YES in step S103), a process for obtaining the document IDs corresponding the documents is conducted (step S104). A flowchart for the process in step S104 is shown in FIG. 11. The process can be commonly applied to the above three types.

As shown in FIG. 11, in order to obtain the document IDs immediately under the target folder, first, the document information table 11 (in FIG. 2A) is accessed (step S111), the parent ID in each record is checked, and the documents are searched for in the document information table 11 where the target folder (folder A, that is, the parent ID “1” in this example) is recorded (step S112). The document IDs of a search result are obtained as target document IDs (step S113). In this example, the document IDs of the documents having the parent ID “1” are “1” (file A) and “2” (book b).

After that, in FIG. 10, the target folder information (folder A, file A, and book B in this example) in which the documents immediately under the target folder are added, and the set access right information (the user name “suzuki” and the access right type “read, write”) are sent to the access right creating part 6 to change the settings of the access rights in response to an instruction of setting or changing the access rights at once, and then, the access right data is created (step S105). After that, the table writing part 7 writes the access right data to the access right information table 16 (step S106), and updates and registers the access right information. Then, the process in accordance with the flowchart in FIG. 10 is terminated.

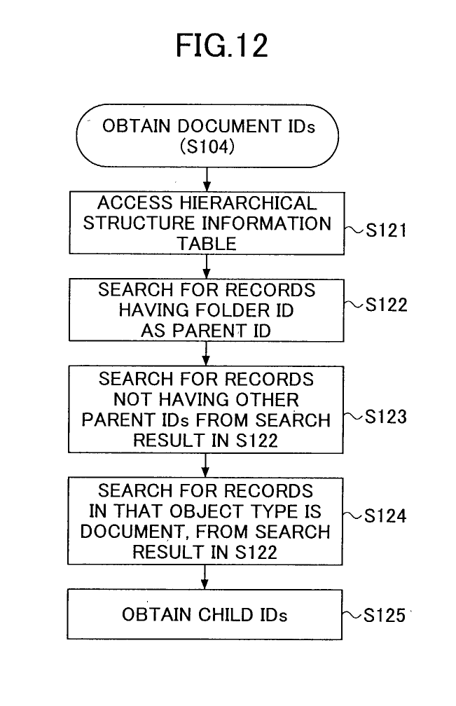

However, as the process (step S104) for obtaining the document IDs immediately under the target folder at once, another method can realize in the “speed first priority type” (in FIG. 6). A flowchart for another method for the “speed first priority type” is shown in FIG. 12.

As shown in FIG. 12, in the flowchart, in order to obtain the document IDs immediately under the target folder, first, the hierarchical structure information table 14 (in FIG. 7) is accessed (step S121), and the parent ID for each record is checked. Then, the child IDs where the target folder instructed to set or change the access right (for example, the folder A, that is, the child ID is “1”) is recorded as the parent ID are searched for from the hierarchical structure information table 14 (step S122). As a search result, the child IDs (including the folders and the documents, which are specified by the child IDs having the parent ID “1”, in this example) are obtained. However, in the child IDs, there are some child IDs belonging to other folders (the folder D and the paper C belonging to the folder B as other folders in this example). Accordingly, it is required to eliminate the child IDs belonging to the other folders. Hence, only documents, which do not have the parent IDs of the other folders, are searched for in step S122 (step S123).

Subsequently, since a search result of S123 includes folders (the folder B and the folder C in this example), these folders need to be eliminated. Then, only documents from the child IDs searched for in step S123 are further searched for (step S124). The document IDs of a search result are obtained as target document IDs (step S125). In this example, the child IDs where the child type is “document” are “1” (folder A) and “2” (book B) (step S125).

As described above, since the hierarchical structure information table 14 (in FIG. 7) includes information of not only the documents immediately under the folder but also the documents belonging to the descendant folders of the folder, it is required to separate the information. In addition, since the hierarchical structure information table 14 includes information of both the documents and the folders, it is also required to separate the information. Accordingly, when the method using the hierarchical structure information table 14 is applied, the speed may be slower than the method using the document information table 11 (in FIG. 11). However, if a DBMS (DataBase Management System) is used, any of two methods described above can be realized by one query sentence. Therefore, it is thought that there is no great difference between two methods described above.

(2) Operation of a Range of “Only Descendant Folders of the Target Folder”

In the operation (2), when the access right is changed so as to add the access right type in respect to the target folder where the access right is already set, the descendant folders of the target folder are added to the range of setting the access right and then the access rights of the target folder and the descendant folders in the range are simultaneously changed.

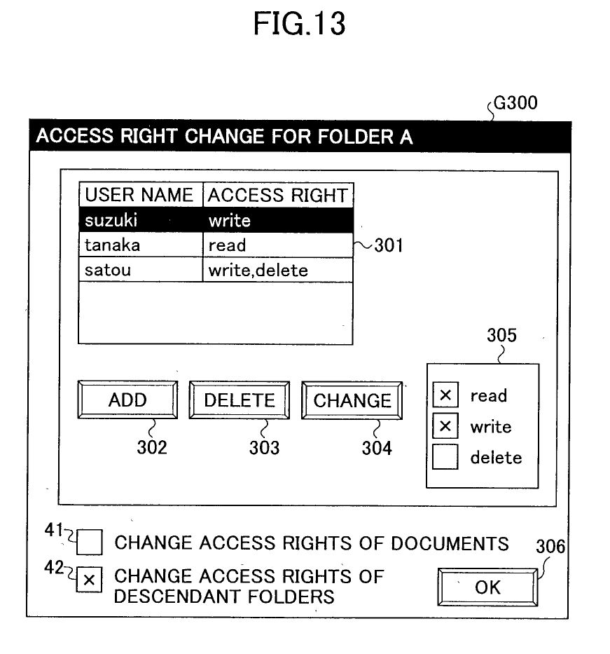

The operations are conducted by the user at the setting operation screen G300 (in FIG. 8) that is the dialog screen. FIG. 13 is a diagram showing an input indicating the range of “only descendant folders of the target folder” at the screen in FIG. 8.

As shown in the list 301 of the setting operation screen G300 in FIG. 13, a state (“read” in the setting area 305 is checked) is illustrated in that the access right “write” is already set for the user “suzuki” in respect to the folder A and the access right “read” is added.

When the checkbox 42 for changing the access rights of the descendant folders is checked, the user “suzuki” and the access right “read, write” are set for the folder A and all descendant folders under the folder A.

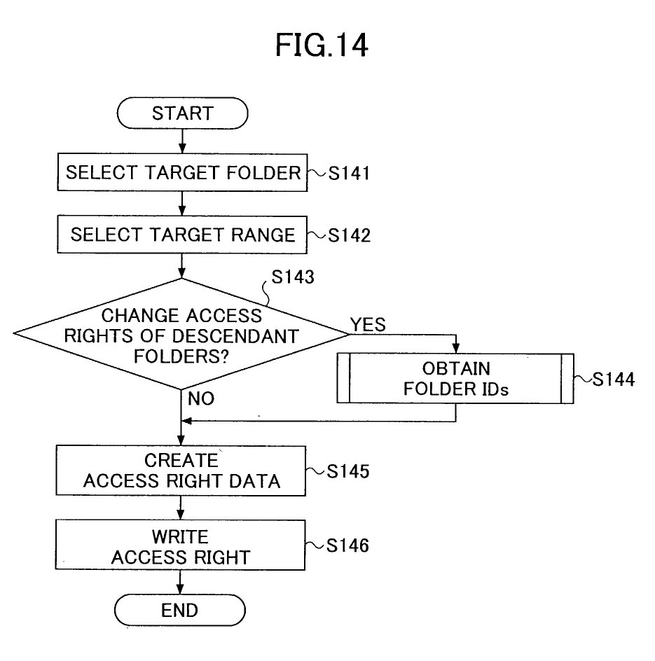

FIG. 14 is a flowchart for explaining the access right change operation in the range of “only descendant folders of the target folder” in accordance with indications at the setting operation screen according to the embodiment of the present invention. The access right setting parts 101, 102, and 103 can realize a process in accordance with the flowchart in FIG. 14 in the “storage area first priority type” (in FIG. 1), the “storage area and speed compromise type” (in FIG. 4), and the “speed first priority type” (in FIG. 6), respectively. However, if a different operation is possible for a part of each type, a different flowchart will be separately applied and described for each type.

Referring to FIG. 14, the user indicates the target folder by the access right setting I/F 1 and calls the setting operation screen G300 (in FIG. 8) for setting and changing the access right of the target folder (step S141). The user indicates changes of the settings of users having the access right or changes of the settings of the access right types for the users, and selects whether only the target folder is set as the range of changing the setting of the access right or the documents immediately under the target folder in addition to the target folder are set as the range of changing the setting of the access rights (step S142). That is, the checkbox 42 for changing the access rights of the descendant folders is checked to change the access rights of all documents immediately under the target folder in addition to the target folder.

This process is branched based on an existence of a check mark indicating whether or not “CHANGE ACCESS RIGHTS OF DESCENDANT FOLDERS” is selected. Thus, it is determined whether or not the checkbox 42 is checked (step S143), that is, it is confirmed whether or not the access rights of the descendant folders are simultaneously changed.

When the checkbox 42 is not checked (NO in step S143), since the access right of only the folder A is changed, in accordance with instructions at the setting operation screen G300 (in FIG. 9), the target folder information (folder A in this example) and the set access right information (user name “suzuki” and access right type “read, write” in this example) are sent to the access right creating part 6 through respective processing parts, and then, the access right data is created (step S145). After that, the table writing part 7 writes the access right data to the access right information table 16 (step S146), and updates and registers the access right information.

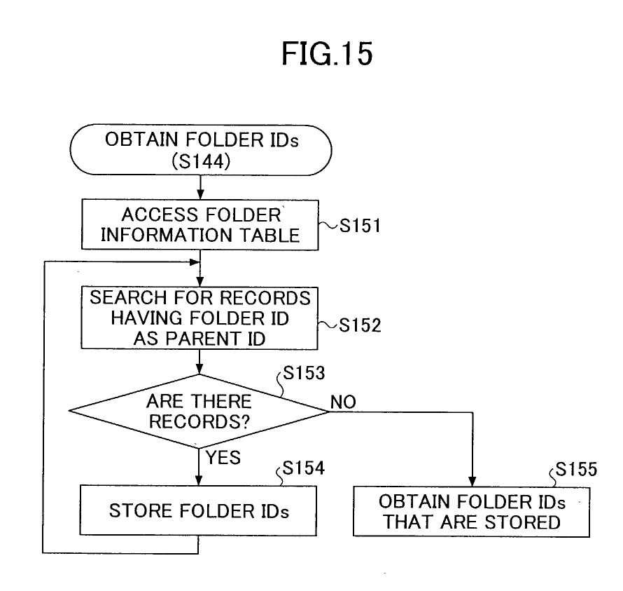

On the other hand, when the checkbox 42 for changing the access rights of the descendant folders is checked (YES in step S143), a process for obtaining the document IDs corresponding the documents is conducted (step S144). Flowcharts for the process in step S144 are shown in FIGS. 15, 16, and 17. The flowcharts can be applied to the above three types, respectively.

FIG. 15 is a flowchart for explaining a process for obtaining the folder IDs in FIG. 14. The process in FIG. 15 is applied to the “storage area first priority type” (in FIG. 1). As shown in FIG. 15, in order to obtain the descendant folder IDs of the target folder, first, the folder information table 12 (in FIG. 2B) is accessed (step S151), the parent ID for each record is checked, and the records are searched for from the folder information table 12 where the target folder (folder A, that is, the parent ID “1” in this example) is recorded (step S152).

As a search result in step S152, when it is determined that there are records (YES in step S153), the folder IDs (folder IDs “2” (folder B) and “3” (folder C) having the parent ID “1” in this example) resulted in step S152 are stored (step S154). Subsequently, step S152 is conducted by using the folder IDs stored in step S154 as search keys. That is, the layer is further lowered, and the folder IDs having a child ID as the parent ID are searched for. In this example, the folder IDs “2” and “3” are the child folders, and the folder having the folder ID “2” or “3” as the parent ID is the folder ID “4” (folder D) where the parent ID is “2”. Then, a search result is stored (step S154), and then, the steps S152 and S153 are repeated. The steps S152 through S154 are repeated until there are no more child folders (NO in step S153), and all folder IDs stored as the search result in step S154 are obtained as the descendant folders (step S155).

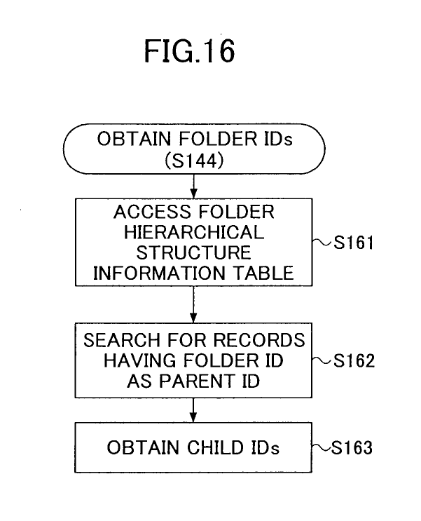

Also, in the “storage area and speed compromise type” (in FIG. 4), steps shown in a flowchart in FIG. 16 can be applied to the process (step S144) for obtaining the descendant folder IDs whose access rights are to be changed at once.

In a flowchart in FIG. 16, in order to obtain the descendant folder IDs under the target folder, first, the folder hierarchical structure information table 13 (in FIG. 5) is accessed (step S161). All folders having the parent ID showing the target folder are searched for from the folder hierarchical structure information table 13 corresponding the parent ID to all descendant folders as the child IDs (step S162). In this case, this search can be conducted by a single operation. The child IDs of a search result in step S162 are obtained (step S163). In this example, the child IDs “2” (folder B), “3” (folder C), and “4” (folder D) are obtained by searching for the parent ID “1”.

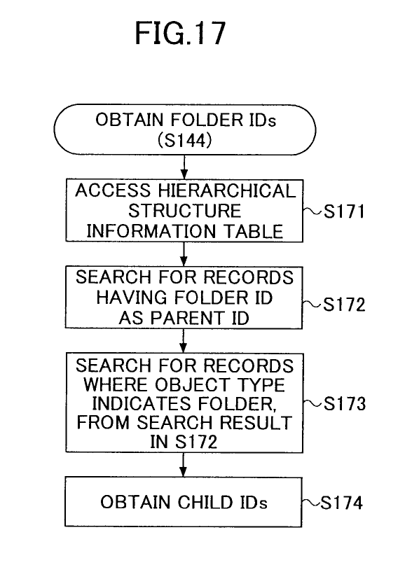

In the “speed first priority type” (in FIG. 6), steps shown in a flowchart in FIG. 17 can be applied to the process (step S144) for obtaining the descendant folder IDs which access rights are to be changed at once.

In the flowchart in FIG. 17, in order to obtain the descendant folder IDs under the target folder, first, the hierarchical structure information table 14 (in FIG. 7) is accessed (step S171). All descendant folders having the parent ID showing the target folder are searched for from the hierarchical structure information table 14 corresponding the parent ID to all descendant folders and all documents belonging to all descendant folders (including all documents belonging to a folder indicated by the parent ID). In this case, by operations at two steps, the child IDs corresponding to the parent ID indicating the target folder are searched for (step S172). Since there are the documents as the descendant folders in a search result of S172, the records in that the object type indicates the folder are further searched for from the search result of S172 (step S173). The child IDs of a search result of step S173 are obtained (step S174). In this example, the child IDs are searched for where the parent ID is “1” and the object type indicates the folder, and then, the child IDs “2” (folder B), “3” (folder C), and “4” (folder D) are obtained (step S174).

As described above, according to the process shown in FIG. 16 for the storage area and speed compromise type (in FIG. 4), since the target child IDs can be obtained by a single search operations, the speed can be improved more than the process shown in FIG. 15 for the storage area first priority type (in FIG. 1). The speed in the process shown in FIG. 17 in the speed first priority type (in FIG. 6) is almost the same as the process shown in FIG. 16 for the storage area and speed compromise type (in FIG. 4). However, there is information of the documents belonging to the descendant folders in addition to the descendant folder information. Accordingly, it is required to separate the information of the documents and the descendant folder information. Therefore, the speed does not change so much but instead one more step is required.

Returning to the flowchart in FIG. 14, as described above, the folder IDs are obtained in any one of the “storage area first priority type”, the “storage area and speed compromise type”, and the “speed first priority type” (step S144). Then, the target folder information (folder A, folder B, folder C, and folder D in this example), in which the descendant folders under the target folder are added to set or change the access rights in accordance with instruction of setting or changing at once, and the set access right information (the user name “suzuki” and the access right type “read, write”) are sent to the access right creating part 6 through relative processing parts, and the access right data is created (step S145), After that, the table writing part 7 writes the access right data to the access right information table 16 (step S146), and updates and registers the access right information. Then, the process in accordance with the flowchart in FIG. 14 is terminated.

(3) Operation of a Range of “Documents Immediately under the Target”

In the operation (3), when the access right is changed so as to add the access right type in respect to the target folder where the access right is already set, in addition to the documents immediately under the target folder, the descendant folders under the target folder and the documents belonging to the descendant folders and the target folder are added to the range of setting the access right and then the access rights of the target folder, the descendant folders, and the documents in the range are simultaneously changed.

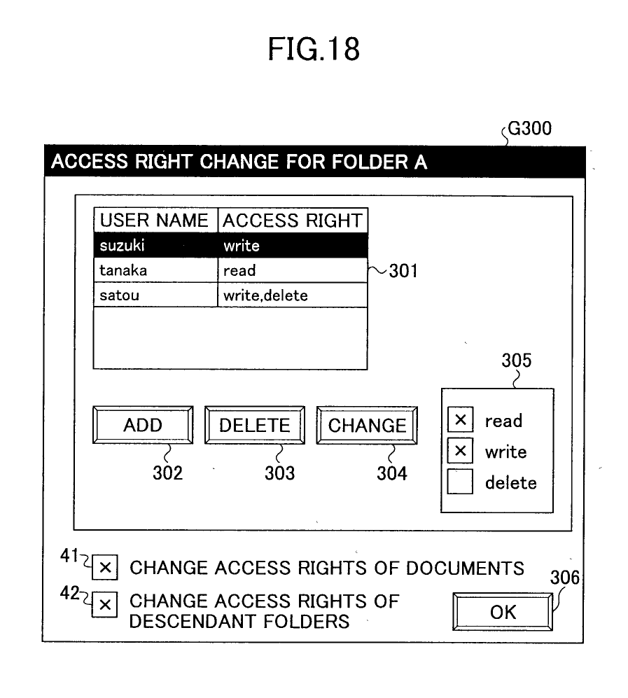

The operations are conducted by the user at the setting operation screen G300 (in FIG. 8) that is the dialog screen. FIG. 18 is a diagram showing an input indicating the range of “documents immediately under the target” at the screen in FIG. 8.

As shown in the list 301 of the setting operation screen G300 in FIG. 18, a state (“read” in the setting area 305 is checked) is illustrated in that the access right “write” is already set for the user “suzuki” in respect to the folder A and the access right “read” is added.

When both the checkbox 41 for changing the access rights of the documents and the checkbox 42 for changing the access rights of the descendant folders are checked, in addition to the documents immediately under the folder A, the user “suzuki” and the access right “read, write” are set for all documents and all descendant folders under the folder A. On the other hand, when the checkboxes 41 and 42 are not checked, only the access right of the folder A is changed.

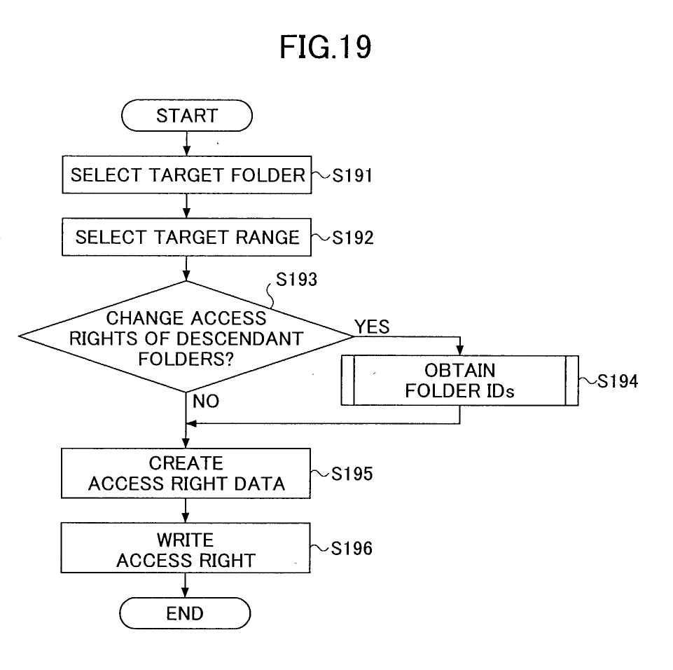

FIG. 19 is a flowchart for explaining an access right change operation in the range of “documents and descendant folders under a target folder in addition to documents immediately under the target folder” in accordance with indications at the setting operation screen according to the embodiment of the present invention. The access right setting parts 101, 102, and 103 can realize a process in accordance with the flowchart in FIG. 19 in the “storage area first priority type” (in FIG. 1), the “storage area and speed compromise type” (in FIG. 4), and the “speed first priority type” (in FIG. 6), respectively. However, if a different operation is possible for a part of each type, a different flowchart will be separately applied and described for each type.

Referring to FIG. 19, the user indicates the target folder by the access right setting I/F 1 and calls the setting operation screen G300 (in FIG. 8) for setting and changing the access right of the target folder (step S191). The user indicates changes of the settings of users having the access right or changes of the settings of the access right types for other users, and selects whether only the target folder is set as the range of changing the setting of the access right or all documents and all descendant folders under the target folder in addition to the documents immediately under the target folder and the target folder are set as the range of changing the setting of the access rights (step S192). That is, both the checkbox 41 for changing the access rights of the documents and the checkbox 42 for changing the access rights of the descendant folders are checked.

This process is branched based on whether or not both the checkbox 41 for changing the access rights of the documents and the checkbox 42 for changing the access rights of the descendant folders. Thus, it is determined whether or not both the checkboxes 41 and 42 are checked, that is, the access rights of the documents and the descendant folders descended from the target folder in addition to the documents immediately under the target folder are simultaneously changed (step S193).

When the checkboxes 41 and 42 are not checked (NO in step S193), since the access right of only the folder A is changed, in accordance with instructions at the setting operation screen G300 (in FIG. 9), the target folder information (folder A in this example) and the set access right information (user name “suzuki” and access right type “read, write” in this example) are sent to the access right creating part 6 through respective processing parts, and then, the access right data are created (step S195). After that, the table writing part 7 writes the access right data to the access right information table 16 (step S196), and updates and registers the access right information.

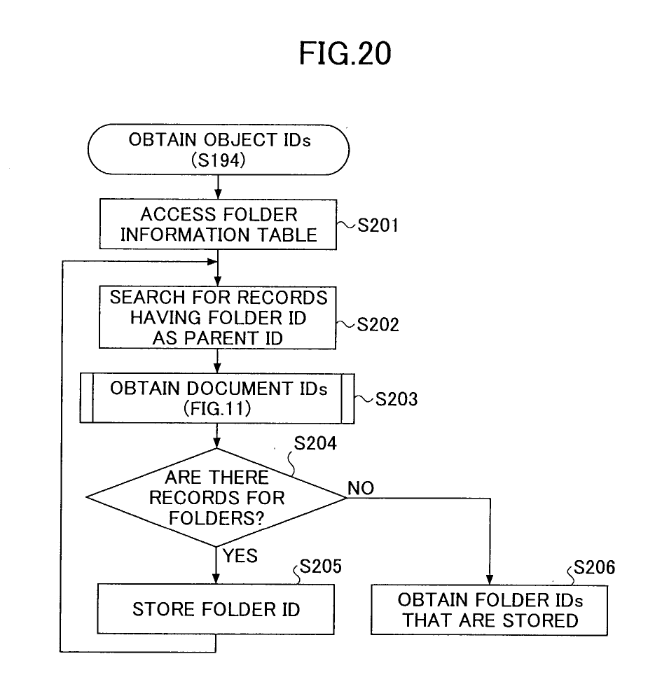

On the other hand, when both the checkboxes 41 and 42 are checked and the documents and the descendant folders descended from the target folder in addition to the documents immediately under the target folder (YES in step S193), a process for obtaining object IDs corresponding to objects (including the folders and the documents) is conducted (step S194). Flowcharts for the process in step S194 are shown in FIGS. 20, 21, and 22. The flowcharts can be applied to the above three types, respectively.

FIG. 20 is a flowchart for explaining a process for obtaining object IDs for the “storage area first priority type” in FIG. 1. The process for obtaining object IDs (in step S194) is based on the flowchart shown in FIG. 20 for the “speed first priority type” in FIG. 1. As shown in FIG. 20, in order to obtain the descendant folder IDs of the target folder, first, the folder information table 12 (in FIG. 2B) is accessed (step S201), the parent ID for each record is checked, and the records are searched for from the folder information table 12 where the target folder which access right is instructed to change is recorded (step S202).

For the folders obtained as a search result in step S202, a process for obtaining the document IDs of the documents immediately under the target folder is conducted (step S203). The same process in accordance with the flowchart shown in FIG. 11 can be applied this process to obtain the document IDs of the documents immediately under the target folder, and an explanation of this process will be omitted. It should be noted that this process instep S203 obtain the folder IDs of the folders searched for in step S202 prior to step S203 and the document IDs of the documents belonging to the descendant folders.

Subsequently, when it is determined that there are records (YES in step S204) as a search result of step S202, the folder ID in each record is stored (step S205). The step S202 is conducted using the folder ID stored in step S205 as the search key, again. That is, the layer is further lowered, and a record where the child ID is the folder ID is searched, and based on this search result, a process for obtaining the document IDs of the documents immediately under the folder is conducted (step S203). Also, the folder IDs searched for in step S203 are stored as the folder IDs (step S205). The steps S202 through S205 are repeated until there is no remaining child folder (NO in step S204). The folder IDs stored in step S205 as the search result are obtained as the descendant folders of the target folder (step S206). And the folder ID stored in step S205 and the document IDs obtained in step S203 are obtained as the object IDs.

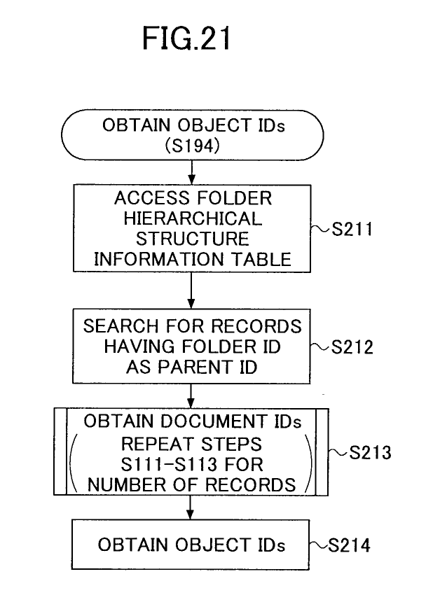

FIG. 21 is a flowchart for explaining a process for obtaining object IDs for the “storage area and speed compromise type” in FIG. 4. The process for obtaining object IDs (in step S194) is based on the flowchart shown in FIG. 21 for the “storage area and speed compromise type” in FIG. 4.

As shown in FIG. 21, in order to obtain the descendant folder IDs of the target folder, first, the folder hierarchical structure information table 13 (in FIG. 5) is accessed (step S211). All descendant folders having the parent ID showing the target folder are searched for from the folder hierarchical structure information table 13 corresponding the parent ID to all descendant folders as the child IDs (step S212). In this case, this search can be conducted by a single operation.

For the folders obtained as a search result in step S212, a process for obtaining the document IDs of the documents immediately under the target folder is conducted (step S213). The same process in accordance with the flowchart shown in FIG. 11 can be applied this process to obtain the document IDs of the documents immediately under the target folder, and an explanation of this process will be omitted. It should be noted that this process in step S213 obtain-the document IDs of the documents belonging to the target folder and the descendant folders searched for in step S212.

The child IDs searched for in step S212 and the document IDs obtained in step S213 are obtained as the object IDs (step S214).

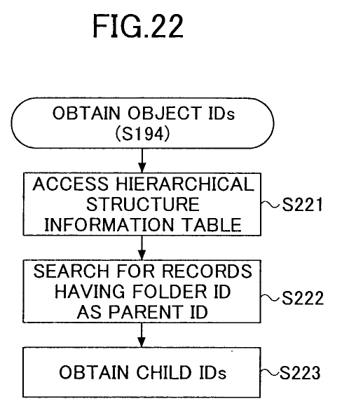

FIG. 22 is a flowchart for explaining a process for obtaining object IDs for the “speed first priority type” in FIG. 6. The process for obtaining object IDs (in step S194) is based on the flowchart shown in FIG. 22 for the “speed first priority type” in FIG. 6.

As shown in FIG. 22, in order to obtain the descendant folder IDs of the target folder, first, the hierarchical structure information table 14 (in FIG. 7) is accessed (step S221). All descendant folders having the parent ID showing the target folder and all documents under the descendant folders are searched for from the hierarchical structure information table 14 corresponding the parent ID to all descendant folders and all documents belonging thereto (including the documents belonging to the folders indicated by the parent IDs) as the child IDs (step S222). In this case, this search can be conducted by a single operation. The child IDs of a search result in step S222 are obtained (step S223).

As described above, according to the flowchart for the “speed first priority type” shown in FIG. 6, since the search can be conducted by the single operation, the process for the “speed first priority type” can be conducted faster than any of the process in FIG. 20 for the “storage area first priority type” shown in FIG. 1 and the process in FIG. 21 for the “storage area and speed compromise type” shown in FIG. 4. The speed of the process in FIG. 21 for the “storage area and speed compromise type” shown in FIG. 4 is somewhat faster than that of the process in FIG. 20 for the “storage area and speed compromise type” shown in FIG. 1.

Returning to the flowchart in FIG. 19, as described above, after the folder IDs are obtained in any one of the “storage area first priority type”, the “storage area and speed compromise type”, and the “speed first priority type” (step S194), the target folder information (folder A, folder B, folder C, folder D, file A, book B, and paper C in this example), in which all documents and all descendant folders under the target folder are added to set or change the access rights in accordance with instruction of setting or changing at once in addition to the documents immediately under the target folder, and the set access right information (the user name “suzuki” and the access right type “read, write”) are sent to the access right creating part 6 through relative processing parts, and the access right data are created (step S195). After that, the table writing part 7 writes the access right data to the access right information table 16 (step S196), and updates and registers the access right information. Then, the process in accordance with the flowchart in FIG. 19 is terminated.

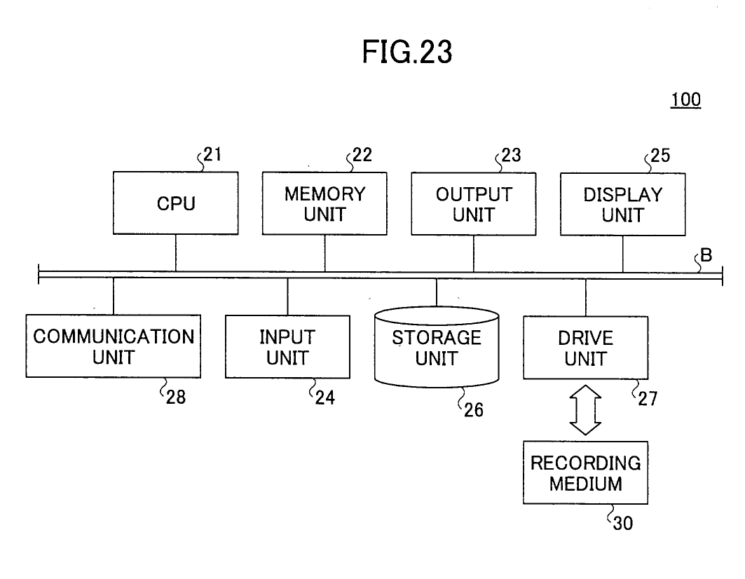

The document processing apparatus including the access right setting parts 101, 102, and 103 is configured such as a hardware configuration shown in FIG. 23. FIG. 23 is a diagram showing the hardware configuration. In FIG. 23, a document processing apparatus 100 is a computer system, and includes a CPU (Central Processing Unit) 21, a memory unit 22, an output unit 23, an input unit 24, a display unit 25, a storage unit 26, a drive unit 27, and a communication unit 28. The CPU 21 and each of the units 22 through 28 are mutually connected via a bus B.

The CPU 21 controls the document processing apparatus 100 in accordance with a program stored in the memory unit 22, and conducts the process for setting or changing the access right described above. The memory unit 22 includes a RAM (Random Access Memory) and a ROM (Read-Only Memory), and stores the program executed by the CPU 21, data necessary for a process by the CPU 21, data obtained by the process by the CPU 21, and the like. Also, the memory unit 22 is partially used as a work area for the CPU 21.

The output unit 23 includes a printer and the like, and outputs information showing a process result or as instructed by the CPU 21. The input unit 24 includes a mouse, a keyboard, and the like, and is used to input various information necessary for conducting the process for setting or changing the access right. The display unit 25 displays various information needed by the user under control of the CPU 21.

For example, the storage unit 26 includes a hard disk unit, and stores the document information table 11, the folder information table 12, the folder hierarchical structure information table 13, the hierarchical structure information table 14, the user information table 15, the access right information table 16, the program, and the like.

For example, the program can be provided to the document processing apparatus 100 by a recording medium 30 such as a CD-ROM (Compact Disc Read-Only Memory) or the like. That is, when the recording medium 30 recording the program according to the process for setting or changing the access right is inserted in the drive unit 27, the drive unit 27 reads the program from the recording medium 30, the program read from the recording medium 30 is installed to the storage unit 26 via the bus B. Then, when the process for setting or changing the access right is executed, the CPU 21 starts the process in accordance with the program installed to the storage unit 26. By the program installed from the recording medium 30 to the document processing apparatus 100, the access right setting I/F 1, the target object determining part 2, the table reading part 3, the access right creating part 6, and the table writing part 7 configures the access right setting parts 101, 102, and 103. It should be noted that the recording medium 30 is not limited to the CD-ROM, but any medium readable for the computer is used as the recording medium 30.

The communication unit 28 conducts communication control between the document processing apparatus 100 and a plurality of terminals in a case in that the document processing apparatus 100 functions as a server computer and connects to the plurality of terminals through a LAN (Local Area Network) and the like. In this case of configuring a network with the plurality of terminals, the document processing apparatus 100 can realize the process for setting or changing the access right by the access right setting part 101, 102, or 103 as a single apparatus, and also can conduct the process for setting or changing the access right in response to requests from the plurality of the terminals.

According to the embodiment of the present invention, first, when changing the access right is instructed in respect to the target folder, the user is allowed to select a part or all of the documents immediately under the target folder, the descendant folders at lower layers than the target folder, and the documents belonging to the descendant folders and to indicate to set or change the access rights at once. Therefore, it is possible to flexibly set the access right by the user and reduce the workload of the user changing the access right.

Second, when changing the access right is instructed in respect to the target folder, the user is allowed to select the documents immediately under the target folder and indicate to set or change the access rights at once. Therefore, it is possible for the user to flexibly set the access right.

Third, when changing the access right is instructed in respect to the target folder, the user is allowed to select the descendant folders at lower layers than the target folder and indicate to set or change the access rights at once. Therefore, it is possible for the user to flexibly set the access right.

Fourth, when changing the access right is instructed in respect to the target folder, the user is allowed to select the documents immediately under the target folder and the descendant folders at lower layers than the target folder and indicate to set or change the access rights at once. Therefore, it is possible for the user to flexibly set the access right.

Fifth, when changing the access right is instructed in respect to the target folder, the user is allowed to select only the target folder to indicate to set or change the access rights. Therefore, it is possible for the user to flexibly set the access right.

Sixth, when changing the access right is instructed in respect to the target folder, the user is allowed to change the setting of a user having the access right or change the setting of the access right type. Therefore, it is possible to diversify the setting of the access right and improve the performance of the process for setting or changing the access right.

The present invention is not limited to the specifically disclosed embodiments, and variations and modifications may be made without departing from the scope of the present invention.

The present application is based on the Japanese priority applications No. 2001-356360 filed on Nov. 21, 2001 and No. 2002-316368 filed on Oct. 30, 2002, the entire contents of which are hereby incorporated by reference.

What is claimed is:

1. A document processing apparatus for controlling access rights of folders and documents in that the documents are maintained in the folders managed in a hierarchical structure, said document processing apparatus comprising:
a change information obtaining part obtaining access right change information indicating a method for setting or changing the access rights indicated by a user by displaying a screen at a display unit, said screen allowing the user to set or change the access rights of the documents managed immediately under a folder indicated by the user and descendant folders lower than the indicated folder; and
an access right changing part changing the access right of the indicated folder and simultaneously changing a part or all of the access rights of the descendant folders obtained based on the hierarchical structure and the documents immediately under the indicated folder and the descendant folders based on the access right change information.

2. The document processing apparatus as claimed in claim 1, wherein said access right changing part includes a first determining part determining whether or not the access right change information obtained from the user by said change information obtaining part indicates to set or change the access rights of the documents immediately under the indicated folder,
wherein based on a determination result by said first determining part and the access right change information, said access right changing part changes the access rights of the indicated folder and the documents immediately under the indicated folder.

3. The document processing apparatus as claimed in claim 1, wherein said access right changing part includes a second determining part determining whether or not the access right change information obtained from the user by said change information obtaining part indicates to set or change the access rights of the descendant folders at lower layers than the indicated folder,
wherein based on a determination result by said second determining part and the access right change information, said access right changing part changes the access rights of the indicated folder and the descendant folders.

4. The document processing apparatus as claimed in claim 1, wherein said access right changing part includes a third determining part determining whether or not the access right change information obtained from the user by said change information obtaining part indicates to set or change the access rights of the documents immediately under the indicated folder and the descendant folders at lower layers than the indicated folder,
wherein based on a determination result by said third determining part and the access right change information, said access right changing part changes the access rights of the indicated folder, the descendant folders, and the documents under the indicated folder and the descendant folders.

5. The document processing apparatus as claimed in claim 1, wherein said access right changing part changes only the access right of the indicated folder when the access right change information obtained from the user by said change information obtaining part does not indicate to set or change the access rights of the documents immediately under the indicated folder and the descendant folders at lower layers than the indicated folder.

6. The document processing apparatus as claimed in claim 1, wherein said access right changing part changes a setting for the user having the access right.

7. The document processing apparatus as claimed in claim 1, wherein said access right changing part changes a setting of an access right type.

8. A program code for causing a computer to control access rights of folders and documents in that the documents are maintained in the folders managed in a hierarchical structure, said program comprising the codes for:
obtaining access right change information indicating a method for setting or changing the access rights indicated by a user by displaying a screen at a display unit, said screen allowing the user to set or change the access rights of the documents managed immediately under a folder indicated by the user and descendant folders lower than the indicated folder; and
changing the access right of the indicated folder and simultaneously changing a part or all of the access rights of the descendant folders obtained based on the hierarchical structure and the documents immediately under the indicated folder and the descendant folders based on the access right change information.

9. A computer-readable recording medium recorded with program code for causing a computer to control access rights of folders and documents in that the documents are maintained in the folders managed in a hierarchical structure, said program comprising the codes for:
obtaining access right change information indicating a method for setting or changing the access rights indicated by a user by displaying a screen at a display unit, said screen allowing the user to set or change the access rights of the documents managed immediately under a folder indicated by the user and descendant folders lower than the indicated folder; and
changing the access right of the indicated folder and simultaneously changing a part or all of the access rights of the descendant folders obtained based on the hierarchical structure and the documents immediately under the indicated folder and the descendant folders based on the access right change information.
